(19) United States
(12) Patent Application Publication
(10) Pub. No.: US 2026/0080312 A1
(43) Pub. Date: Mar. 19, 2026

(54) INFORMATION PROCESSING APPARATUS

(71) Applicant: NEC Corporation, Tokyo (JP)

(72) Inventors: Masakazu HIROKAWA, Tokyo (JP); Keita SAKUMA, Tokyo (JP); Ryuta MATSUNO, Tokyo (JP)

(73) Assignee: NEC Corporation, Tokyo (JP)

(21) Appl. No.: 19/316,166

(22) Filed: Sep. 2, 2025

(30) Foreign Application Priority Data
Sep. 18, 2024 (JP) 2024-160796

(51) Int. Cl. G06N 20/00; G06F 17/18

(52) U.S. Cl. CPC G06N 20/00; G06F 17/18

(57) ABSTRACT

An information processing apparatus according to the present disclosure includes an acquisition unit for acquiring a set of datasets including input data to be input to a machine learning model, output data to be output from the machine learning model according to the input data, and an evaluation value indicating evaluation of the output data for the input data, a generation unit for generating a distribution of the evaluation value in the set of the datasets, and a calculation unit for calculating a value of a preset index in the dataset, based on the distribution.

### INCORPORATION OF BASIC APPLICATION

The present invention claims the benefit of the priority of Japanese Patent Application No. 2024-160796 filed on September 18, 2024 in Japan, the contents of which are incorporated herein by reference in its entirety.

### TECHNICAL FIELD

The present disclosure relates to an information processing apparatus.

### BACKGROUND ART

In recent years, a machine learning model that performs an output for a request from a user is utilized, in various scenes. For example, as described in JP 7404596 B1, Large Language Models (LLM) that have learned language processing are utilized, and a user can obtain an output of a verbal answer, by inputting a verbal question. Then, such a large language model executes fine adjustment processing (alignment) in such a way as to obtain an output preferable for humans, after performing machine learning using enormous learning data.

### SUMMARY

However, as described above, there has been a problem in that it is difficult to select learning data to be used at the time of alignment after a large language model is machine learned. Not only the large language model but also various machine learning models have similar problems.

Therefore, one of objects of the present disclosure is to solve the problem in that it is difficult to select learning data to be used when a machine learning model is aligned.

An information processing apparatus according to one aspect of the present disclosure includes

an acquisition unit for acquiring a set of datasets including input data to be input to a machine learning model, output data to be output from the machine learning model according to the input data, and an evaluation value indicating evaluation of the output data for the input data,

a generation unit for generating a distribution of the evaluation value in the set of the datasets, and

a calculation unit for calculating a value of a preset index in the dataset, based on the distribution.

An information processing method according to one aspect of the present disclosure performed by an information processing apparatus, includes

acquiring a set of datasets including input data to be input to a machine learning model, output data to be output from the machine learning model according to the input data, and an evaluation value indicating evaluation of the output data for the input data,

generating a distribution of the evaluation value in the set of the datasets, and

calculating a value of a preset index in the dataset, based on the distribution.

A program according to one aspect of the present disclosure for causing an information processing apparatus to execute processing includes

acquiring a set of datasets including input data to be input to a machine learning model, output data to be output from the machine learning model according to the input data, and an evaluation value indicating evaluation of the output data for the input data,

generating a distribution of the evaluation value in the set of the datasets, and

calculating a value of a preset index in the dataset, based on the distribution.

With the above configuration, the present disclosure can easily select learning data to be used when a machine learning model is aligned.

### BRIEF DESCRIPTION OF THE DRAWINGS

FIG. 1 is a block diagram illustrating an example of a configuration of an evaluation device according to the present disclosure;

FIG. 2 is a block diagram illustrating an example of the configuration of the evaluation device according to the present disclosure;

FIG. 3 is a diagram illustrating an example of a state of processing of the evaluation device according to the present disclosure;

FIG. 4 is a diagram illustrating an example of the state of the processing of the evaluation device according to the present disclosure;

FIG. 5 is a diagram illustrating an example of the state of the processing of the evaluation device according to the present disclosure;

FIG. 6 is a flowchart illustrating an example of a processing operation of the evaluation device according to the present disclosure;

FIG. 7 is a block diagram illustrating an example of a hardware configuration of an information processing apparatus according to the present disclosure; and

FIG. 8 is a block diagram illustrating an example of a configuration of the information processing apparatus according to the present disclosure.

### EXAMPLE EMBODIMENT

A first example embodiment of the present disclosure will be described with reference to the drawings. The drawings may relate to any example embodiment.

As an example, an evaluation device 10 according to the present disclosure is used to support decision making for selecting learning data to be used when alignment which is additional learning processing for performing fine adjustment in such a way as to obtain an output preferable for humans is performed on a machine learning model that has performed machine learning using learning data. As an example, in the present example embodiment, it will be described as assuming that a machine learning model to be aligned is a large language model. However, the machine learning model to be aligned is not limited to the Large Language Models (LLM) and may be a machine learning model that performs any output for any input. Accordingly, learning data used for machine learning may be any data.

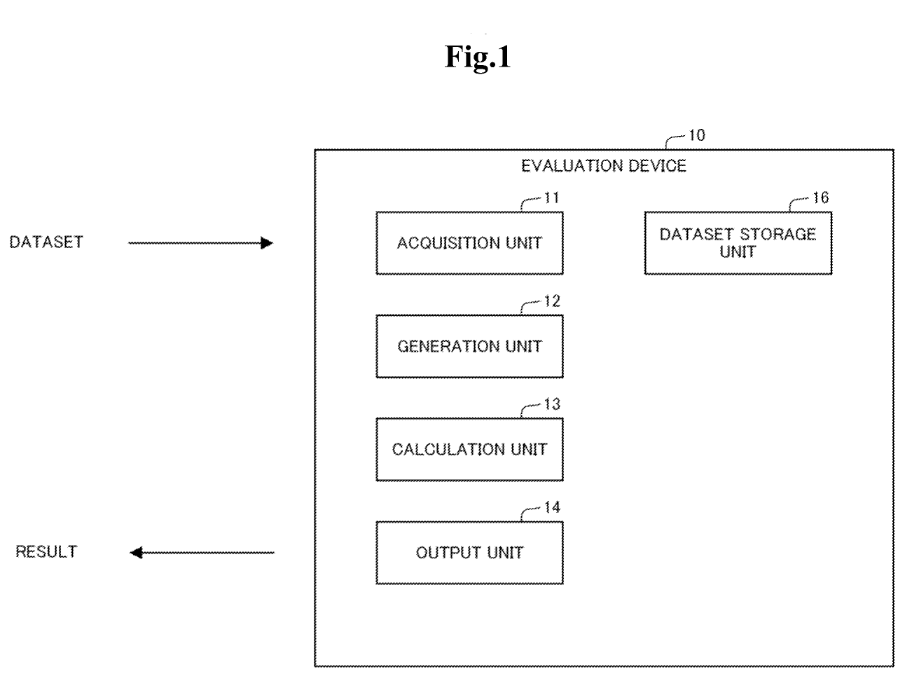

The evaluation device 10 includes a single or a plurality of information processing apparatuses including an arithmetic device and a storage device. Then, as illustrated in FIG. 1, the evaluation device 10 includes an acquisition unit 11, a generation unit 12, a calculation unit 13, and an output unit 14. Each of functions of the acquisition unit 11, the generation unit 12, the calculation unit 13, and the output unit 14 can be achieved by executing a program for achieving each function stored in the storage device, by the arithmetic device. The evaluation device 10 includes a dataset storage unit 16 including the storage device.

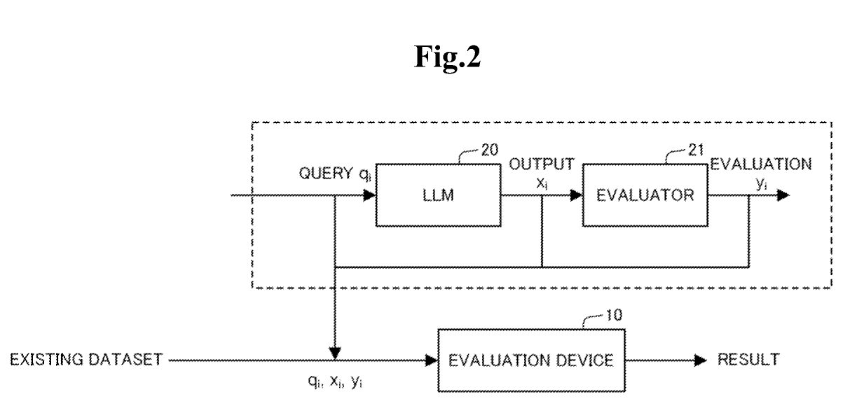

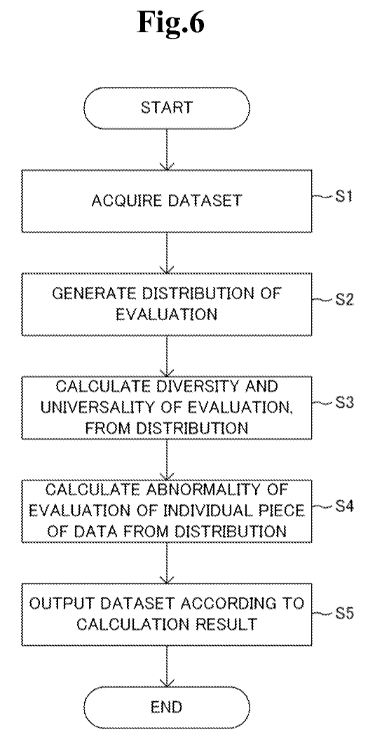

The acquisition unit 11 acquires a set of datasets of a query qᵢ that is input data to be input into an LLM 20, an output xᵢ that is output data to be output from the LLM 20 according to the query qᵢ, and evaluation yᵢ of the output xᵢ for the query qᵢ and stores the set in the dataset storage unit 16 (step S1 in FIG. 6). At this time, the dataset including the query qᵢ, the output xᵢ, and the evaluation yᵢ may be an existing dataset and may be a dataset acquired from the operated LLM 20, as illustrated in FIG. 2.

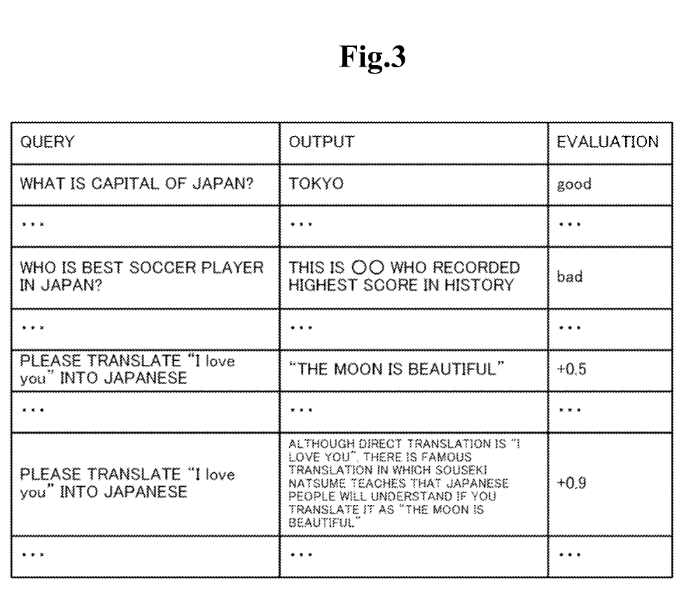

Here, a specific example of the dataset is illustrated in FIG. 3. The query qᵢ of the dataset is a verbal question for the LLM 20, and as an example, “What is the capital of Japan?” is exemplified. The output xᵢ of the dataset is a verbal answer from the LLM 20 to the above question, and as an example, “Tokyo” is exemplified. Then, the evaluation yᵢ of the dataset is evaluation by a predetermined evaluator 21 for the answer to the question described above, and “good” is an example. The evaluation yᵢ is expressed as “good” in a case where the evaluator 21 positively evaluates that the answer to the question is appropriate or can be approved and is expressed as “bad” in a case where the evaluator 21 negatively evaluates that the answer is not appropriate or cannot be approved. Therefore, the evaluation yᵢ may be a different value depending on background knowledge of the evaluator 21 and a lapse of time (changes of the times), even if the answer is for the same question. The evaluation yᵢ may be expressed by a discrete value such as a binary of “good” and “bad” or more stepwise values and may be expressed as continuous values, within a range of “0.0” to “1.0”, that increase as the evaluation becomes more positive.

As illustrated in FIG. 3, as another example of the dataset, the query qᵢ “Who is the best soccer player in Japan?”, the output xᵢ “This is ○○ who recorded the highest score in the history”, and the evaluation yᵢ “bad” are exemplified. As still another example of the dataset, the query qᵢ “Please translate “I love you” into Japanese”, the output xᵢ “The moon is beautiful”, and the evaluation yᵢ “0.5” are exemplified. As still yet another example of the dataset, the query qᵢ “Please translate “I love you” into Japanese”, the output xᵢ “Although direct translation is “I love you”, there is a famous translation in which Souseki Natsume teaches that Japanese people will understand if you translate it as “The moon is beautiful””, and the evaluation yᵢ “0.9” are exemplified. In this way, the dataset includes a dataset that has the output xᵢ having different content for the same or similar query qᵢ.

The acquisition unit 11 may acquire option information associated with the dataset. The option information of the dataset includes input characteristic information indicating characteristics of the query qᵢ and evaluator characteristic information indicating characteristics of an evaluator. The input characteristic information is, for example, a type of the query qᵢ, and as an example, a question, a translation, a summary, or the like that is a type of content of the query qᵢ is exemplified, and in addition, text, voice, or the like that is a type of expression of the query qᵢ is exemplified. The evaluator characteristic information is, for example, an attribute of the evaluator, and as an example, gender, age, residence, nationality, identification information, or the like of the evaluator is exemplified.

The generation unit 12 generates a distribution of evaluation yᵢ in the set of the datasets (step S2 in FIG. 6). At this time, the generation unit 12 classifies the set of the datasets into a similar set (Q, X) that is a set of pairs of the same or similar query qᵢ and the same or similar output xᵢ for the same or similar query qᵢ and generates a distribution of an evaluation set (evaluation Y) related to each dataset of the similar set (Q, X). At this time, the similar set (Q, X) includes a set of queries qᵢ having a high sentence similarity based on a preset criterion and a set of outputs xᵢ for the query qᵢ and having a high sentence similarity based on a preset criterion. The similar set (Q, X) may be classified, for example, by the large language model, may be classified by another information processing apparatus, or may be manually classified. The dataset collected by the acquisition unit 11 may already form the similar set (Q, X).

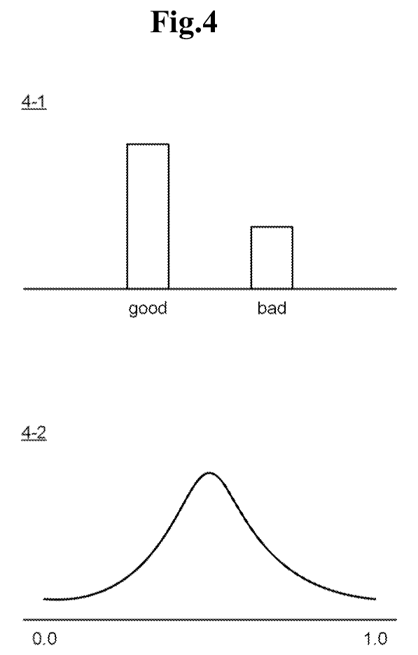

Then, the generation unit 12 generates a distribution indicating a variation degree of the evaluation Y or a degree of a temporal change, as the distribution of the evaluation Y in the similar set (Q, X). For example, the generation unit 12 generates the distribution of the variation degree as illustrated in FIG. 4 (4-1), for the evaluation yᵢ of the discrete value and generates the distribution of the variation degree as illustrated in FIG. 4 (4-2), for the evaluation yᵢ of the continuous values. The generation unit 12 may generate the distribution of the variation degree for each time of the evaluation yᵢ and generate the degree of the temporal change. Moreover, the generation unit 12 may generate an odds ratio or a cumulative probability of a binomial distribution for the evaluation yᵢ of the discrete value or may generate a peakedness, a skewness, or the like, for the evaluation yᵢ of the continuous values. The generation unit 12 may generate any distribution, as the distribution of the evaluation Y in the similar set (Q, X).

The generation unit 12 may classify the similar set (Q, X) classified based on a similarity between the query qᵢ and the output xᵢ as described above, based on a similarity of the option information of the dataset. For example, the similar set (Q, X) may be classified into the similar set (Q, X) having the same or similar type of the query qᵢ (question, translation, summary, text, voice, or the like) or the attribute of the evaluator (gender, age, residence, nationality, identification information, or the like). Then, similarly to the above, the generation unit 12 may generate the distribution of the evaluation Y in the similar set (Q, X) classified by the type of the classified query qᵢ or the attribute of the evaluator.

The calculation unit 13 calculates a value of a preset index in the dataset, based on the distribution of the evaluation Y of the similar set (Q, X) generated as described above. Specifically, the calculation unit 13 calculates the index of the evaluation Y that can be read from the distribution of the evaluation Y of the similar set (Q, X). As an example, the calculation unit 13 calculates a diversity and an universality of the evaluation Y, as the index of the evaluation Y in the similar set (Q, X) (step S3 in FIG. 6).

Specifically, the calculation unit 13 can calculate a value of the diversity according to the variation degree, from the distribution of the variation degree of the evaluation Y as illustrated in FIG. 4 and can calculate the value, for example, within a range of “0.0” to “1.0” in such a way that the larger the variation, the larger the value of the diversity. The calculation unit 13 can calculate a value of the universality according to a coincidence degree of the distribution with the temporal change, from the distribution of the degree of the temporal change of the evaluation Y, and can calculate the value, for example, within the range of “0.0” to “1.0” in such a way that the larger the coincidence degree of the distribution with the temporal change, the larger the universality. As a result, since the answer to the question is true and universal for the similar set (Q, X) related to the query qᵢ “What is the capital of Japan?” and the output xᵢ “Tokyo” in the dataset as illustrated in FIG. 3, the value of the diversity may be calculated to be low, and the value of the universality may be calculated to be high. On the other hand, since the answer to the question depends on an answerer and has contents that change with time, for the similar set (Q, X) related to the query qᵢ “Who is the best soccer player in Japan?” and the output xᵢ “This is ○○ who recorded the highest score in the history” in the dataset as illustrated in FIG. 3, the value of the diversity may be calculated to be high, and the value of the universality may be calculated to be low. The calculation unit 13 may calculate any index, from any distribution as described above, as well as the diversity and the universality described above.

The calculation unit 13 calculates an abnormality of a dataset, as the index of the predetermined dataset included in the similar set (Q, X), based on the distribution of the evaluation Y of the similar set (Q, X) generated as described above (step S4 in FIG. 6). Specifically, the calculation unit 13 obtains an occurrence probability of the evaluation yᵢ in the predetermined dataset in the similar set (Q, X) and calculates an abnormality according to the occurrence probability. That is, a degree of deviation of the evaluation yᵢ of the predetermined dataset for standard evaluation, in the similar set (Q, X), is calculated as an abnormality of the predetermined dataset. For example, in the range of “0.0” to “1.0”, it can be calculated such that the lower the occurrence probability, the larger the abnormality.

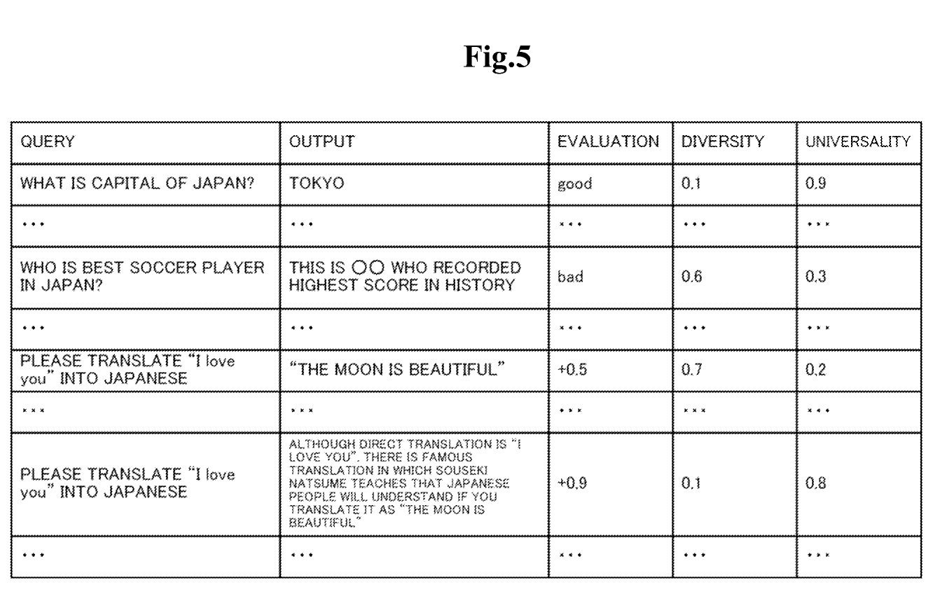

The output unit 14 outputs the dataset, based on the index such as the diversity, the universality, or the abnormality calculated as described above (step S5 in FIG. 6). For example, the output unit 14 outputs the dataset to be displayed on a display device according to the index, for an operator who operates the machine learning model. At this time, as illustrated in FIG. 5, the output unit 14 outputs the index such as the diversity or the universality calculated as described above, in association with the dataset. In a case of calculating the abnormality of the dataset, the output unit 14 may output the abnormality in association with the dataset. Moreover, the output unit 14 may output the type of the query qᵢ or the attribute of the evaluator that is the option information associated with the dataset, in association with the dataset.

The output unit 14 may output the dataset, in consideration of appropriateness of use for alignment, according to the index such as the calculated diversity, universality, or abnormality. For example, the output unit 14 may output a dataset that satisfies criteria such as a low diversity, a high universality, or a low abnormality, as a dataset suitable for the use for the alignment. Alternatively, the output unit 14 may output the dataset, not suitable for the alignment, not to be used, according to the index.

As described above, in the present disclosure, the index such as the diversity, the universality, or the abnormality is calculated from the distribution of the evaluation of the dataset, and the operator of the machine learning model refers to the index in such a way that it becomes easier to select learning data to be used at the time of alignment of the machine learning model. For example, the operator of the machine learning model can select the learning data with emphasis on a dataset with a low diversity and a high universality or can select the learning data excluding a dataset with a high abnormality. By outputting the dataset in association with the option information, it is possible to select the learning data in consideration of a bias of the evaluation based on the type of the input of the dataset and the attribute of the evaluator. Then, as described above, by selecting the learning data, the machine learning model can be created at low cost, and reliability and accuracy of the output of the machine learning model can be improved.

<Second Example Embodiment>

Next, a second example embodiment of the present disclosure will be described with reference to the drawings. In the present example embodiment, an outline of the evaluation device or the like described in the above example embodiment is illustrated. The drawings may relate to any example embodiment.

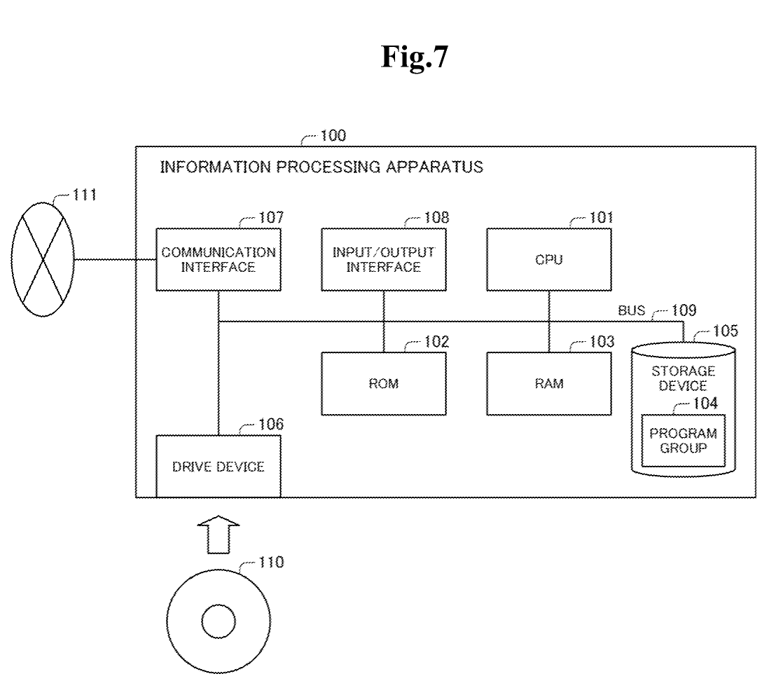

First, a hardware configuration of an information processing apparatus 100 according to the present disclosure will be described. The information processing apparatus 100 includes a general information processing apparatus and has the following hardware configuration, as illustrated in FIG. 7, as an example.

A Central Processing Unit (CPU) 101 (arithmetic device)

A Read Only Memory (ROM) 102 (storage device)

A Random Access Memory (RAM) 103 (storage device)

A program group 104 loaded into the RAM 103

A storage device 105 storing the program group 104

A drive device 106 that reads and writes a storage medium 110 outside the information processing apparatus

A communication interface 107 connected to a communication network 111 outside the information processing apparatus

An input/output interface 108 for inputting/outputting data

A bus 109 for connecting each component

FIG. 7 illustrates an example of the hardware configuration of the information processing apparatus that is the information processing apparatus 100, and the hardware configuration of the information processing apparatus is not limited to the above case. For example, the information processing apparatus may have a part of the above configuration such as a configuration that does not include the drive device 106. Instead of the CPU described above, the information processing apparatus can use a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, a combination of these, or the like.

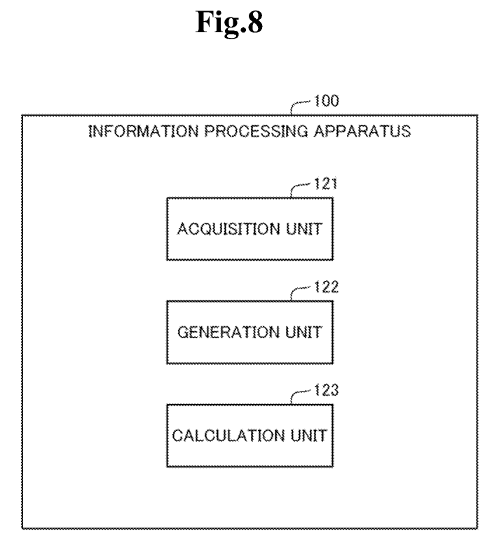

Then, the CPU 101 acquires and executes the program group 104 in such a way that the information processing apparatus 100 can construct and equip an acquisition unit 121, a generation unit 122, and a calculation unit 123 illustrated in FIG. 8. The program group 104 is stored, for example, in the storage device 105 or the ROM 102, and the CPU 101 loads and executes the program group 104 on the RAM 103 as necessary. The program group 104 may be supplied to the CPU 101 via the communication network 111 or the drive device 106 may read the program stored in the storage medium 110 in advance and supply to the CPU 101. However, the acquisition unit 121, the generation unit 122, and the calculation unit 123 described above may be constructed by a dedicated electronic circuit for achieving the means.

The acquisition unit 121 acquires a set of datasets including the input data to be input to the machine learning model, the output data to be output from the machine learning model according to the input data, and an evaluation value indicating evaluation of the output data for the input data. The generation unit 122 generates a distribution of the evaluation value in the set of the datasets. The calculation unit 123 calculates a value of a preset index in the dataset, based on the distribution.

With the above configuration, the present disclosure easily selects the dataset as the learning data to be used at the time of alignment of the machine learning model, by calculating the index from the distribution of the evaluation value of the dataset and referring to the index by the operator of the machine learning model.

At least one or more of the functions of the acquisition unit 121, the generation unit 122, and the calculation unit 123 described above may be executed by an information processing apparatus installed and connected at any place on a network, that is, so-called cloud computing.

The program described above can be stored using various types of non-transitory computer readable media (non-transitory computer readable medium) and supplied to a computer. The non-transitory computer readable media include various types of tangible recording media (tangible storage media). Examples of the non-transitory computer readable medium include a magnetic recording medium (for example, a flexible disk, a magnetic tape, or a hard disk drive), an optical magnetic recording medium (for example, a magneto-optical disk), a compact disc-Read Only Memory (CD-ROM), a CD-R, a CD-R/W, and a semiconductor memory (for example, a mask ROM, a Programmable ROM (PROM), an Erasable PROM (EPROM), a flash ROM, or a Random Access Memory (RAM)). The program may be supplied to the computer by various types of transitory computer readable media (transitory computer readable medium). Examples of the transitory computer readable media include electrical signals, optical signals, and electromagnetic waves. The transitory computer readable media can supply the program to the computer via a wired communication line such as an electric wire and optical fibers or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment described above can be appropriately combined with other example embodiments.

### <Supplementary Note>

Some or all of the above example embodiments may be described as in the following Supplementary Notes. Hereinafter, an outline of configurations of an information processing apparatus, an information processing method, and a program according to the present disclosure will be described. However, the present disclosure is not limited to the configuration described in the following Supplementary Notes.

Some or all of the configurations described in the Supplementary Notes 2 to 8 dependent on the Supplementary Note 1 described above and some or all of the functions of the configurations can also be dependent on the other Supplementary Notes 9 and 10 by the dependency relationship similar to the Supplementary Notes 2 to 8. Moreover, some or all of the configurations described as the Supplementary Notes and some or all of the functions of the configurations can be similarly dependent on not only the Supplementary Notes 1, 9, and 10, but also various pieces of hardware and software, and various types of recording means or systems for recording the software without departing from the above-described example embodiments.

### (Supplementary Note 1)

An information processing apparatus including:

an acquisition unit for acquiring a set of datasets including input data to be input to a machine learning model, output data to be output from the machine learning model according to the input data, and an evaluation value indicating evaluation of the output data for the input data;

a generation unit for generating a distribution of the evaluation value in the set of the datasets; and

a calculation unit for calculating a value of a preset index in the dataset, based on the distribution.

### (Supplementary Note 2)

The information processing apparatus according to supplementary note 1, further including:

an output unit for outputting information for specifying the dataset, based on a calculation result of the index.

### (Supplementary Note 3)

The information processing apparatus according to supplementary note 2, in which

the output unit outputs the calculation result of the index in association with the information for specifying the dataset.

### (Supplementary Note 4)

The information processing apparatus according to supplementary note 1, in which

the calculation unit calculates a diversity of the evaluation value in the dataset, as the index, based on the distribution.

### (Supplementary Note 5)

The information processing apparatus according to supplementary note 1, in which

the calculation unit calculates an universality of the evaluation value in the dataset, as the index, based on the distribution.

### (Supplementary Note 6)

The information processing apparatus according to supplementary note 1, in which

the calculation unit calculates an abnormality of the evaluation value in the dataset, as the index, based on the distribution.

### (Supplementary Note 7)

The information processing apparatus according to supplementary note 2, in which

the acquisition unit acquires the dataset including input characteristic information indicating characteristics of the input data, and

the output unit outputs the input characteristic information, in association with the information for specifying the dataset.

### (Supplementary Note 8)

The information processing apparatus according to supplementary note 2, in which

the acquisition unit acquires the dataset including evaluator characteristic information indicating characteristics of an evaluator of the evaluation value, and

the output unit outputs the evaluator characteristic information, in association with the information for specifying the dataset.

### (Supplementary Note 9)

An information processing method performed by an information processing apparatus, the method including:

acquiring a set of datasets including input data to be input to a machine learning model, output data to be output from the machine learning model according to the input data, and an evaluation value indicating evaluation of the output data for the input data;

generating a distribution of the evaluation value in the set of the datasets; and

calculating a value of a preset index in the dataset, based on the distribution.

### (Supplementary Note 9.1)

The information processing method according to supplementary note 9, further including:

outputting information for specifying the dataset, based on a calculation result of the index.

### (Supplementary Note 9.2)

The information processing method according to supplementary note 9.1, further including:

outputting the calculation result of the index, in association with the information for specifying the dataset.

### (Supplementary Note 9.3)

The information processing method according to supplementary note 9.1, further including:

acquiring the dataset including input characteristic information indicating characteristics of the input data; and

outputting the input characteristic information, in association with the information for specifying the dataset.

### (Supplementary Note 9.4)

The information processing method according to supplementary note 9.1, further including:

acquiring the dataset including evaluator characteristic information indicating characteristics of an evaluator of the evaluation value; and

outputting the evaluator characteristic information, in association with the information for specifying the dataset.

### (Supplementary Note 10)

A program for causing an information processing apparatus to execute processing including:

acquiring a set of datasets including input data to be input to a machine learning model, output data to be output from the machine learning model according to the input data, and an evaluation value indicating evaluation of the output data for the input data;

generating a distribution of the evaluation value in the set of the datasets; and

calculating a value of a preset index in the dataset, based on the distribution.

1. An information processing apparatus comprising:
at least one memory configured to store processing instructions; and
at least one processor configured to execute the processing instructions to:
acquire a set of datasets that includes input data to be input to a machine learning model, output data to be output from the machine learning model according to the input data, and an evaluation value indicating evaluation of the output data for the input data,
generate a distribution of the evaluation value in the set of the datasets, and
calculate a value of a preset index in the dataset, based on the distribution.

2. The information processing apparatus according to claim 1, wherein the at least one processor is configured to execute the processing instructions to
output information for specifying the dataset, based on a calculation result of the index.

3. The information processing apparatus according to claim 2, wherein the at least one processor is configured to execute the processing instructions to
output the calculation result of the index, in association with the information for specifying the dataset.

4. The information processing apparatus according to claim 1, wherein the at least one processor is configured to execute the processing instructions to
calculate a diversity of the evaluation value in the dataset, as the index, based on the distribution.

5. The information processing apparatus according to claim 1, wherein the at least one processor is configured to execute the processing instructions to
calculate an universality of the evaluation value in the dataset, as the index, based on the distribution.

6. The information processing apparatus according to claim 1, wherein the at least one processor is configured to execute the processing instructions to
calculate an abnormality of the evaluation value in the dataset, as the index, based on the distribution.

7. The information processing apparatus according to claim 2, wherein the at least one processor is configured to execute the processing instructions to
acquire the dataset including input characteristic information indicating characteristics of the input data, and
output the input characteristic information, in association with the information for specifying the dataset.

8. The information processing apparatus according to claim 2, wherein the at least one processor is configured to execute the processing instructions to
acquire the dataset including evaluator characteristic information indicating characteristics of an evaluator of the evaluation value, and
output the evaluator characteristic information, in association with the information for specifying the dataset.

9. The information processing apparatus according to claim 2, wherein the at least one processor is configured to execute the processing instructions to
output information for supporting decision making for selecting learning data to be used for alignment of the machine learning model, based on the calculation result of the index.

10. An information processing method performed by an information processing apparatus, the method comprising:
acquiring a set of datasets including input data to be input to a machine learning model, output data to be output from the machine learning model according to the input data, and an evaluation value indicating evaluation of the output data for the input data;
generating a distribution of the evaluation value in the set of the datasets; and
calculating a value of a preset index in the dataset, based on the distribution.

11. The information processing method according to claim 10, further comprising:
outputting information for specifying the dataset, based on a calculation result of the index.

12. The information processing method according to claim 11, further comprising:
outputting the calculation result of the index, in association with the information for specifying the dataset.

13. The information processing method according to claim 11, further comprising:
acquiring the dataset including input characteristic information indicating characteristics of the input data; and
outputting the input characteristic information, in association with the information for specifying the dataset.

14. The information processing method according to claim 11, further comprising:
acquiring the dataset including evaluator characteristic information indicating characteristics of an evaluator of the evaluation value, and
outputting the evaluator characteristic information, in association with the information for specifying the dataset.

15. A computer readable storage medium storing a program for causing an information processing apparatus to execute processing comprising:
acquiring a set of datasets including input data to be input to a machine learning model, output data to be output from the machine learning model according to the input data, and an evaluation value indicating evaluation of the output data for the input data;
generating a distribution of the evaluation value in the set of the datasets; and
calculating a value of a preset index in the dataset, based on the distribution.
